(19) United States
(12) Patent Application Publication
(10) Pub. No.: US 2026/0337326 A1
(43) Pub. Date: Oct. 29, 2026

(54) PERFLUOROPOLYETHER POLYMERS

(71) Applicant: SYENSQO SPECIALTY POLYMERS ITALY S.p.A., Bollate (Milano) (IT)

(72) Inventors: Andrea Lotierzo, Brugherio (MB) (IT); Ugo De Patto, Cogliate (MB) (IT)

(73) Assignee: SYENSQO SPECIALTY POLYMERS ITALY S.p.A., Bollate (Milano) (IT)

(21) Appl. No.: 19/116,880

(22) PCT Filed: Sep. 26, 2023
(86) PCT No.: PCT/EP2023/076612

§ 371 Date: Mar. 28, 2025

(30) Foreign Application Priority Data
Sep. 28, 2022 (EP) 22198270.5

(51) Int. Cl. C08F 297/00; C08L 53/00

(52) U.S. Cl. CPC C08F 297/00; C08L 53/00; C08F 2800/20; C08L 2207/324

(57) ABSTRACT

The present invention relates to new copolymers comprising (per)fluoropolyether chains and functional groups.

### CROSS REFERENCE TO RELATED PATENT APPLICATIONS

This patent application claims priority filed on 28 Sep. 2022 in Europe with Nr 22198270.5, the whole content of this application being incorporated herein by reference for all purposes.

### TECHNICAL FIELD

The present invention relates to new copolymers comprising (per)fluoropolyether chains and functional groups.

### BACKGROUND ART

(Per) fluoropolyether polymers (in the following referred to as “PFPE polymers”) have been long known as base oils or as additives in several lubricant applications.

Several syntheses of PFPE polymers have been disclosed in the art. The first synthesis of unspecified perfluorinated polyether mixtures was reported in 1953, when an oily product was obtained in the course of photoligomerization of hexafluoropropene. Since then, a number of different perfluorinated polyethers have been synthesised and described in literature.

U.S. Pat. No. 4,500,739 (in the name of Montedison) discloses the reaction of a peroxidic PFPE with—among the others—perfluoro butadiene (Group II of fluoroolefins). Example 4 discloses the reaction with perfluoro butadiene, with a large excess of perfluorinated bis-olefin, resulting in pendant unsaturated groups along the macromolecular chain such that the reaction can further proceed in the presence of hexamethylenediamine.

U.S. Pat. No. 8,258,090 (in the name of Solvay Solexis S.p.A.) discloses fluorinated lubricants of formula:

T-O-[A-B]z-[A′-B′]z′-A-T (I)
wherein
T and T′ are C₁₋₃ perfluoroalkyl or C₁₋₆ alkyl,
A and A are a perfluoropolyether chain,
B derives from two different olefins, of which at least one homopolymerizable by radical route, of formula:

—[(CR₁R₂—CR₃R₄)ⱼ—(CR₅R₆—CR₇R₈)ⱼ′]— (Ia)
wherein
j is from 1 to 5, j′ is from 0 to 4 and the sum of j+j′ is between 2 and 5;
R₁ to R₈ are halogen, H, C₁₋₆ (per)haloalkyl, C₁-6 alkyl, C₁-6 oxy (per)fluoroalkyl;
z is higher than or equal to 2, z′ is an integer and the sum of z and z′ is such that the number average molecular weight of the polymer of formula (I) is in the range 500-500000;
B′ is (la) but at least one of R₁ to R₈ has a meaning different from that in B.

This patent discloses block copolymers characterised by a linear backbone, without any branching. Indeed, no branching is obtained within B, notably comprising (per)fluoropolyether chains.

PFPE polymers comprising functional groups along the backbone have been disclosed in the art, being useful as reactive intermediate compounds and as additives.

Perfluoropolyether polymers obtained from the reaction of polyperoxidic perfluoropolyether and fluorinated olefin in the presence of U.V. radiation have been disclosed in U.S. Pat. No. 4,500,739 (Montedison S.p.A., Feb. 19, 1985).

U.S. Pat. No. 6,403,539 (Ausimont S.p.A., Jun. 11, 2002) discloses perfluoro-polyether polymers containing sulphonyl fluoride groups pending along the backbone. This patent application discloses a process wherein the sulphonyl fluoride-containing monomer is contemporaneously fed with an O₂ flow in a liquid reaction medium, thus obtaining perfluoropolyethers containing in the chain peroxidic groups. However, the presence of the peroxidic groups is not desired for safety concerns. Hence, this patent application discloses that to obtain non peroxidic products without chain scission, the peroxidic perfluoropolyethers are subjected to a thermal treatment at temperatures generally in the range from 150 °C to 250 °C or to a photochemical treatment, optionally in the presence of a solvent. The process herein disclosed—in which the functionalized monomer is added at the beginning of the polymerization—does not allow the synthesis of a polymer having segregated blocks from the functionalized monomer but rather it allows for the synthesis of a PFPE polymer having randomly distributed functional groups.

Polyfunctional (per)fluoropolyether polymers have been further disclosed in U.S. Pat. No. 5,719,259 (E.I. DuPont de Nemours and Company, Feb. 17, 1998), U.S. Pat. No. 4,853,097 (Ausimont S.r.l., Aug. 1, 1989), U.S. Pat. No. 5,104,911 (Ausimont S.r.l., Apr. 14, 1992).

US 2011/0230631 (Solvay Solexis S.p.A, Sep. 22, 2011) discloses (per)fluoropolyethers comprising at least one (per)fluoropolyoxyalkylene chain comprising at least one recurring unit of formula —CF₂—CF(CF₂O—SO₂F)—O—, wherein fluorosulfate group in brackets is a pendant group, which is subsequently reacted with a nucleophilic agent to provide functional groups, such as notably carboxylic acid, acyl fluoride, amide and esters.

CN 103724559 (ZHONGHAO CHENGUANG RES INST CHEMICAL IND, Apr. 16, 2014) discloses a method comprising placing the perfluoropolyether peroxide prepared by a photo-oxidation method in an inert fluorine-containing solvent, introducing perfluoro-olefin under an ultraviolet irradiation condition, and reacting the perfluoro-olefin with the peroxide to form a stable perfluoropolyether compound.

WO 2019/048394 (Solvay Specialty Polymers Italy S.p.A., Mar. 14, 2019) discloses polyfunctional perfluoropolyether derivatives including a plurality of ionisable groups selected from the group consisting of —SO₃Xa, —PO₃Xa and —COOXa, wherein Xa is H, ammonium group or a monovalent metal.

### SUMMARY OF INVENTION

The Applicant developed new co-polymers comprising (per)fluoropolyether chains and (per) fluorinated co-monomers, whose properties—for example with respect to their viscosity and/or physical appearance—can be properly tuned based on their intended final use.

More in particular, the Applicant faced the problem of preparing new co-polymers comprising (per)fluoropolyether chains characterised by increased viscosity (as measured by complex viscosity at 0.1 rad/s at 25 °C).

According to an embodiment, the new copolymers according to the present invention show a low glass transition temperature (T_{g}) and are in the liquid state at room temperature. However, if desired, the new copolymers according to the present invention can be provided in a solid form, such as in particular as rubbers, or in a semi-solid form.

Furthermore, the Applicant developed new copolymers comprising functional groups, which can be advantageously introduced as pendant groups along the main backbone of the PFPE copolymers to make them suitable for use as additives in different technical fields, including as anti-rust, anti-wear, to increase compatibility among base oils and thickeners and other ingredients dispersed in such base oils.

### DETAILED DESCRIPTION OF THE INVENTION

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “perfluoropolyether” and, when used as substantive, is intended to mean either the singular or the plural form, depending on the context;
the term “functionality (F)” is intended to indicate the amount of functional groups in the copolymer according to the present invention as measured via NMR or titration.

In a first aspect, the present invention relates to a block copolymer [copolymer (P)] comprising a first and a second perfluoropolyether chain [PFPE chain] each having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —C(═O)F and —OC(═O)F, and the second chain ends of said first and second PFPE chain are bonded to each other via:
at least one first block [block (1)] complying with formula (I):

—[CR₁₀₀R₁₀₁—CR₁₀₂R₁₀₃]_{L\hat{ }}-(D)L- (I)
wherein
L\hat{ } is 0 or an integer from 1 to 250;
R₁₀₀, R₁₀₁, R₁₀₂ and R₁₀₃ are each independently selected from halogen atom, more preferably fluorine or chlorine atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms, such as oxygen atoms;
L is 0 or an integer from 1 to 250, and
D is a group of formula —(CR_{100*}R_{101*}—CR_{102*}R_{103*})— wherein at least one of R₁₀₀+, R_{101*}R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—;
with the proviso that, when L\hat{ } and L are both different from 0, the recurring units are statistically distributed;
   at least one second block [block (2)] complying with formula (II):

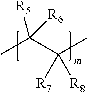

wherein
m is 0 or an integer from 1 to 5;
R₅ to R₈, each independently, is selected in the group comprising, preferably consisting of, —F, perfluorinated linear or branched alkyl chain having from 1 to 6 carbon atoms, and group of formula (III):

—R₂₀—(X)_{y} (III)
wherein
R₂₀ is a sigma bond, or linear or branched perfluoroalkyl chain comprising from 1 to 12 carbon atoms, preferably comprising and/or interrupted by at least one oxygen atom,
X is a functional group, preferably selected from: —SO₂F, —SO₃H, —COOH, —COF, —CN, —Br and —CONH₂; and
y is an integer equal to 1 or 2;
with the proviso that in formula (II), at least one, preferably one, of R₅ to R₈ is group of formula (III);
   at least one third block [block (3)] complying with formula (IV):

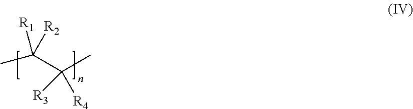

wherein
n is an integer from 1 to 3;
R₁ to R₄, each independently, is selected in the group comprising, preferably consisting of, fluorine atom, perfluorinated linear or branched alkyl group having from 1 to 6 carbon atoms, group of formula (V):

—(R₁₀)ₜ[C(R₁₁)(R₁₂)—C(R₁₃)(R₁₄)(R₁₅)]_{z} (V)
wherein
R₁₀ is an oxygen atom, or a bi-/tri-/tetravalent perfluorinated alkyl chain comprising from 1 to 24 carbon atoms and being optionally interrupted by at least one oxygen atom,
t is zero or 1,
z is an integer from 1 to 3,
R₁₁ to R₁₅, each independently, is selected in the group comprising, preferably consisting of: fluorine atom, perfluorinated linear or branched alkyl group having from 1 to 6 carbon atoms and group of formula (VI):

-[(A)ₐ-(B)_{b}-(E)-(F)_{f}]ᵤ-(A)-T (VI)
wherein
u is zero or an integer from 1 to 50;
T is a perfluorinated alkyl group;
a is zero or 1,
each A is a PFPE chain;
b is zero or an integer from 1 to 3,
B is a block of formula (IV*):

—[C(R_{1\hat{ }})(R_{2\hat{ }})—C(R_{3\hat{ }})(R_{4\hat{ }})]— (IV*)
wherein
R_{1\hat{ }} to R_{4\hat{ }} each independently has the meaning defined above for each of R₁ to
R₄, respectively;
E is a block of formula (I*)

—[CR_{100\hat{ }}R_{101\hat{ }}—CR_{102\hat{ }}R_{103\hat{ }}]_{e\hat{ }}-(D*)_{e*}- (I*)
wherein
e\hat{ } has the same meaning provided above for L\hat{ },
each of R_{100\hat{ }}R_{101\hat{ }}, R_{102\hat{ }} and R_{103\hat{ }} has the same meaning provided above for
R₁₀₀, R₁₀₁, R₁₀₂ and R₁₀₃, respectively,
e* has the same meaning provided above for L, and
D* has the same meaning provided above for D,
with the proviso that, when e\hat{ } and e* are both different from 0, the recurring units are statistically distributed;
f is 0 or an integer from 1 to 5, preferably from 1 to 2;
F is a block of formula (II*):

—[C(R_{5\hat{ }})(R_{6\hat{ }})—C(R_{7\hat{ }})(R_{8\hat{ }})]—
wherein
R_{5\hat{ }} to R_{8\hat{ }}, each independently, has the meaning provided above for each of R₅ to R₈, respectively;
with the proviso that:
   in said formula (IV), at least one of R₁ to R₄ is a group of formula (V),
   in said formula (IV*), at least one of R_{1\hat{ }} to R_{4\hat{ }} is a group of formula (V)
   in said formula (V), one of R₁₁ or R₁₂ and one of R₁₃ to R₁₅, is a group of formula (VI),
   in said formula (VI), the recurring units (A), (B), (E) and (F) are statistically distributed;
and
   optionally, at least one fourth block [block (4)] comprising a PFPE chain;
with the proviso that, in copolymer (P):
   the sum of (L+L\hat{ }+e\hat{ }+e*) is at least 1, preferably from 1 to 500, more preferably from 2 to 500, more preferably from 2 to 300;
   the sum of (m+f) is at least 1, preferably from 1 to 100;
   the sum of (n+b) is at least 1, preferably from 1 to 15, more preferably from 1 to 11, even more preferably from 1 to 9; and
   said at least one block (1), said at least one block (2), said at least one block (3) and, when present, said at least one block (4) are statistically distributed.

Advantageously, copolymer (P) according to the invention can be provided in liquid form or in semi-solid form. However, when required by the final use, copolymer (P) can also be provided in the form of solid, such as a rubber.

Advantageously, copolymer (P) is characterised by a complex viscosity, measured at 0.1 rad/s and at 25 °C, varying in a large range, such as from 10 Pas to more than 2000 Pa*s.

It will be understood by those skilled in the art that said first chain end of said first and second PFPE chain correspond to the two chain ends of copolymer (P).

Preferably, in copolymer (P), each of said PFPE chain is a fully fluorinated chain [chain (R_{f})] comprising, preferably consists of, repeating units R°, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

Preferably, chain (R_{f}) complies with the following formula:

—[(CFX¹O)_{g1}(CFX²CFX³⁰)_{g2}(CF₂CF₂CF₂O)_{g3}(CF₂CF₂CF₂CF₂O)_{g4}]— (Rf-I)
wherein
   X¹ is independently selected from —F and —CF₃,
   X², X³, equal or different from each other and at each occurrence, are independently —F, —CF₃, with the proviso that at least one of X is —F;
   g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (Rf-IIA)
wherein:
   a1 and a2 are independently integers ≥0 such that the number average molecular weight is between 400 and 100,000 as determined via NMR, preferably between 400 and 50,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b4}]— (Rf-IIB)
wherein:
b1, b2, b3, b4, are independently integers ≥0 such that the number average molecular weight is between 400 and 100,000 as determined via NMR, preferably between 400 and 50,000; preferably each of b1, b2, b3, b4 are >0;

—[(CF₂CF₂O)_{c1}(CF₂O)_{c2}(CF₂(CF₂)_{cw}CF₂O)_{c3}]— (Rf-IIC)
wherein:
cw=1 or 2;
c1, c2, and c3 are independently integers ≥0 chosen so that the number average molecular weight is between 400 and 100,000 as determined via NMR, preferably between 400 and 50,000; preferably c1, c2 and c3 are all >0, with the ratio c3/(c1+c2) being generally lower than 0.2.

Still more preferably, chain (R_{f}) complies with formula (Rf-III) here below:

—[(CF₂CF₂O)ₐ₁(CF₂O)ₐ₂]— (Rf-III)
wherein:
   a1, and a2 are integers ≥0 such that the number average molecular weight is between 400 and 100,000 as determined via NMR, preferably between 400 and 50,000, with the ratio a1/a2 being generally between 0.1 and 10, more preferably between 0.2 and 5.

Preferably, in block (1), at least one of L\hat{ } and L is different from 0.

Preferably, in block (1), both L\hat{ } and L are different from 0.

Preferably, R₁₀₀, R₁₀₁, R₁₀₂ and R₁₀₃, each independently, is a halogen atom, such as fluorine atom or chlorine atom.

Preferably, in block (2), m is 0 or an integer from 1 to 2.

Preferably, in block (2), one of R₅ to R& is a group of formula (V).

Preferably, in block (2), R₂₀ is a sigma bond or a group selected from those of formula (R₂₀-i) to (R₂₀-iv) as defined hereinafter:

—(CF₂)ₛ₁—O—(CF₂)ₛ₂— (R₂₀-i)
wherein each of s1 and s2 is independently an integer from 1 to 6, preferably from 1 to 3;

—O—(CF₂)ₛ₃— (R₂₀-ii)
wherein s3 is an integer from 1 to 6, preferably from 1 to 5;

—O—R₄₀₀—O—R₄₀₁— (R₂₀-iii)
wherein
R₄₀₀ is a linear or branched perfluorinated alkyl chain comprising from 1 to 6, preferably from 1 to 3, carbon atoms, and more preferably complying with formula
—CF₂—, —CF₂CF₂—, —CF₂CF₂CF₂—, —CF₂CF(CF₃)—; and
R401 is a linear or branched perfluorinated alkyl chain comprising from 1 to 3 carbon atoms, more preferably complying with formula —CF₂—, —CF₂CF₂—, —CF(CF₂)—;

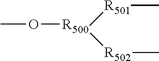

wherein
R₅₀₀ is a linear perfluorinated alkyl chain comprising from 1 to 6 carbon atoms, preferably from 1 to 3 carbon atoms and optionally interrupted by at least one oxygen atom;
R₅₀₁ is a chain of formula —OR₅₀₃ wherein R₅₀₃ is a linear perfluorinated alkyl chain comprising from 1 to 3 carbon atoms;
R₅₀₂ is a linear perfluorinated alkyl chain comprising from 1 to 4 carbon atoms and optionally interrupted by at least one oxygen atom;
each of R₅₀₁ and R₅₀₂ bonding a group X as defined above.

Preferably, in block (3) and formula (V), R₁₀ complies with one of the following formulae:

—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and
R_{CF} is either a perfluoroalkyl chain comprising from 1 to 12, preferably from 1 to 8 carbon atoms, optionally interrupted by one or more oxygen atoms

—O—(C₃F₆O)ₕ—(CF₂)ᵢ—(C₃F₆O)ⱼ—O— (R₁₀-ii)
wherein h=j and h+j is from 2 to 6, and i is from 2 to 6.

In a second aspect, the present invention relates to a process [process (P)] for the manufacture of copolymer (P) as defined above. The process according to the present invention can be easily scaled up from laboratory scale to pilot and industrial scale.

Advantageously, copolymer (P) of the present invention is prepared via process (P) comprising at least the following steps:
(a) contacting:
   at least one perfluoropolyether polymer comprising at least one peroxidic group [PFPE peroxy];
   at least one compound [compound (O)] selected in the group comprising, preferably consisting of:
(i) fully halogenated olefin comprising from 2 to 15 carbon atoms;
(ii) CF₂═CFOR_{f},
wherein
R_{f} is a C₁-C₆ (per)fluoroalkyl group, preferably-CF₃, —C₂F₅, —C₃F₇; a group C₁-C₁₂ [(per)fluoro]-oxyalkyl comprising catenary oxygen atoms, preferably perfluoro-2-propoxypropyl group;
(iii) CF₂═CFOCF₂OR₁₂
wherein
R₁₂ is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R₁₂ is —CF₂CF₃, —CF₂CF₂OCF₃, or —CF₃;
(iv) CF₂═CFCF₂OR₁₇
wherein
R_{f2} is selected from the group consisting of C₁-C₆ perfluoro-alkyls, C₅-C₆ cyclic perfluoro-alkyls, and C₂-C₆ perfluoro-oxy-alkyls, comprising at least one catenary oxygen atom;
(v) perfluorodioxoles having formula:

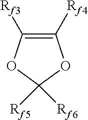

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃;
   at least one perfluorinated compound of formula (X-p):

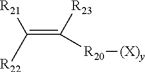

wherein
each of R₂₁ to R₂₃ is independently —F or perfluorinated linear or branched alkyl chain having from 1 to 6 carbon atoms,
R₂₀, X and y are as defined above for formula (III);
at least one perfluorinated compound of formula (XX-p):

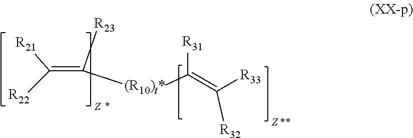

wherein
each of R₂₁ to R₂₃ are as defined above in formula (X-p),
each of R₃₁ to R₃₃ is independently —F or perfluorinated alkyl group having from 1 to 6 carbon atoms,
R₁₀ is an oxygen atom, a perfluorinated alkyl chain comprising from 1 to 24 carbon atoms, optionally interrupted by at least one oxygen atom,
t is zero or 1;
each of z* and z** is independently 1 or 2; and
(b) reacting said PFPE peroxy, said at least one compound of formula (X-p), said at least one compound of formula (XX-p) and at least one compound (O) in the presence of UV radiation or under heating.

An advantage of the process for the manufacture of copolymer (P) according to the present invention is that the amounts of the reactants providing each of block (1), block (2) and block (3) can be tuned and selected a priori based on the desired properties of the final copolymer (P). This is advantageous as selecting a priori the amount of the reactants allows to tune the number of each block (1), block (2) and block (3) in copolymer (P).

In step (a), the order in which the reactants are added is not limited. Accordingly, the PFPE peroxy, the compound of formula (X-p), the compound of formula (XX-p) and the compound (O) can be supplied to the reaction environment in any order.

Before step (a), the PFPE peroxy can be subjected to partial reduction of the peroxide bonds, for example by chemical reduction or UV treatment or thermal treatment.

Preferably, said PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain [chain (R_{f})] comprising, preferably consisting of, repeating units (R°) being independently selected from the group consisting of formulae (i) to (v) as above defined and having a peroxidic content (PO), defined as grams of active oxygen (Mw=16) in 100 g of PFPE peroxy between 0.1 and 4, preferably between 0.1 and 3.5.

Preferably, in said PFPE peroxy, chain (R_{f}) complies with formulae (Rf-I), or (Rf-IIA), (Rf-IIB), (Rf-IIC) or (Rf-III) as defined above.

According to a preferred embodiment, step (a) of the process of the present invention is performed with at least one compound (O).

Preferably, said at least one compound (O) is selected in the group comprising, preferably consisting of:
(i) fully halogenated olefin comprising from 2 to 10 carbon atoms, preferably from 2 to 8 carbon atoms. More preferably, it is selected in the group comprising: tetrafluoroethylene (TFE), hexafluoropropylene (HFP), chlorotrifluoroethylene (CTFE). TFE and HFP being particularly preferred.

When two or more compounds (O) are used, preferably, the first compound (O) is selected from those defined in (i) above and a second compound (O) is selected in the group comprising, more preferably consisting of:
(ii) CF₂═CFOR_{f},
wherein
R_{f} is a C₁-C₆ (per)fluoroalkyl group, preferably-CF₃, —C₂F₅, —C₃F₇; a group C₁-C₁₂ [(per)fluoro]-oxyalkyl comprising catenary oxygen atoms, preferably perfluoro-2-propoxypropyl group;
(iii) CF₂═CFOCF₂OR₁₂
wherein
R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R₁₂ is —CF₂CF₃, —CF₂CF₂OCF₃, or —CF₃;
(iv) CF₂═CFCF₂OR₁₇
wherein
R_{f7} is selected from the group consisting of C₁-C₆ perfluoro-alkyls, C₅-C₆ cyclic perfluoro-alkyls, and C₂-C₆ perfluoro-oxy-alkyls, comprising at least one catenary oxygen atom;
(v) perfluorodioxoles having formula:

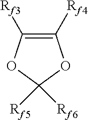

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃.

Preferably, in said at least one compound of formula (X-p), each of R₂₁, R₂₂ and R₂₃ is —F.

Preferably, in said compound (X-p), R₂₀ is a sigma bond or a group selected from those of formula (R₂₀-i) to (R₂₀-iv) as defined hereinafter:

(CF₂)ₛ₁—O—(CF₂)ₛ₂— (R₂₀-i)
wherein each of s1 and s2 is independently an integer from 1 to 6, preferably from 1 to 3;

—O—(CF₂)ₛ₃— (R₂₀-ii)
wherein s3 is an integer from 1 to 6, preferably from 1 to 5;

—O—R₄₀₀—O—R₄₀₁— (R₂₀-iii)
wherein
R₄₀₀ is a linear or branched perfluorinated alkyl chain comprising from 1 to 6, preferably from 1 to 3, carbon atoms, and more preferably complying with formula —CF₂—, —CF₂CF₂—, —CF₂CF₂CF₂—, —CF₂CF(CF₃)—; and
R401 is a linear or branched perfluorinated alkyl chain comprising from 1 to 3 carbon atoms, more preferably complying with formula —CF₂—, —CF₂CF₂—, —CF(CF₂)—:

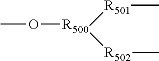

wherein
R₅₀₀ is a linear perfluorinated alkyl chain comprising from 1 to 6 carbon atoms, preferably from 1 to 3 carbon atoms and optionally interrupted by at least one oxygen atom;
R₅₀₁ is a chain of formula —OR₅₀₃ wherein R₅₀₃ is a linear perfluorinated alkyl chain comprising from 1 to 3 carbon atoms;
R₅₀₂ is a linear perfluorinated alkyl chain comprising from 1 to 4 carbon atoms and optionally interrupted by at least one oxygen atom;
each of R₅₀₁ and R₅₀₂ bonding a group X as defined above.

Preferably, said at least one compound of formula (X-p) is selected in the group comprising, more preferably consisting of:
CF₂═CFCF₂OCF₂CF₂COOH
CF₂═CFOCF₂COOH
CF₂═CFO(CF₂)₅COOH
CF₂═CFOCF₂CF₂OCF₂COOH
CF₂═CFOCF₂CF₂COOH
CF₂═CFCF₂OCF₂CF₂COF
CF₂═CFOCF₂COF
CF₂═CFO(CF₂)₃OCF(CF₃)COF
CF₂═CFO(CF₂)₅COF
CF₂═CFOCF₂CF(CF₃)OCF₂CF₂CN
CF₂═CFOCF₂CN
CF₂═CFO(CF₂)₅CN
CF₂═CFO(CF₂)₃OCF(CF₃)CN
CF₂═CFCF₂OCF₂CF₂CN
CF₂═CFOCF₂CF₂Br
CF₂═CFCF₂OCF₂CF₂Br
CF₂═CFOCF₂CF(CF₃)OCF₂CF₂Br
CF₂═CFCF₂OCF₂CF₂CONH₂
CF₂═CFOCF₂CONH₂
CF₂═CFOCF₂CF₂CONH₂
CF₂═CFOCF₂CF₂SO₂F
CF₂═CFSO₂F
CF₂═CFOCF₂CF(SO₂F)₂
CF₂═CFOCF₂CF(CF₂OCF₂CF₂SO₂F) (OCF₂CF₂SO₂F)
CF₂═CFOCF₂CF(CF₂CF₂SO₂F) (OCF₂CF₂SO₂F)
CF₂═CFOCF₂OCF₂CF(CF₂OCF₂CF₂SO₂F) (SO₂F).

Some exemplary compounds of formula (X-p) and the preparation thereof are provided in WO 03/106515 (in the name of Daikin Ind.), JP 2017-025242 (in the name of ASAHI GLASS CO., LTD.) and in US 2008/138685 (in the name of AGC Inc.).

Preferably, in said compound of formula (XX-p), when t is 1, the one, two, three or four unsaturated moieties are bonded to the same or different atoms, preferably carbon atoms, belonging to R₁₀.

Preferably, said at least one compound of formula (XX-p) complies with the following formula:

CF₂═CF(R₁₀)ⱼCF═CF₂
wherein t is zero or 1, and
R₁₀ complies with one of the following formulae:

—(CF₂)_{d}(O)ₑ(CF₂O)_{f}R_{CF}(O)_{e*}(CF₂)_{d*}(CF₂O)— (R₁₀-i)
wherein
each of d, d*, e, e*, f and f* is independently zero or 1 and
R_{CF} is either a perfluoroalkyl chain comprising from 1 to 12, preferably from 1 to 8 carbon atoms, optionally interrupted by one or more oxygen atoms

—O—(C₃F₆O)ₕ—(CF₂)ᵢ—(C₃F₆O)ⱼ—O— (R₁₀-ii)
wherein h=j and h+j is from 2 to 6, and i is from 2 to 6.

According to a particularly preferred embodiment, said at least one compound of formula (XX-p) complies with the following formula:

CF₂═CF(R₁₀)ⱼCF═CF₂
wherein t is 1 and
R₁₀ complies with formula:

—(CF₂)_{d}(O)_{d}(CF₂O)ₑR_{CF}(O)_{e*}(CF₂)_{d*}(CF₂O)_{f*} (R₁₀-i)
wherein
d, f, d* and f* are zero,
e and e* are 1, and
R_{CF} is a linear perfluoroalkyl chain comprising from 1 to 10, preferably from 1 to 8 carbon atoms.

Preferably, said compound of formula (XX-p) is selected from the group comprising, more preferably consisting of:
CF₂═CFCF═CF₂
CF₂═CFOCF═CF₂
CF₂═CFCF₂OCF₂CF═CF₂
CF₂═CFO—(CF₂)₃CF═CF₂
CF₂═CFCF₂₀ (CF₂)₃OCF₂—CF═CF₂
CF₂═CFCF₂CF═CF₂
CF₂═CF(CF₂)₂CF═CF₂
CF₂═CF(CF₂)₃CF═CF₂
CF₂═CF(CF₂)₄CF═CF₂
CF₂═CFOCF₂OCF═CF₂
CF₂═CFO(CF₂)₂OCF═CF₂
CF₂═CFO(CF₂)₃OCF═CF₂
CF₂═CFO(CF₂)₄OCF═CF₂
CF₂═CF(CF₂)₂OCF═CF₂
CF₂═CF(CF₂)₃OCF═CF₂
CF₂═CF(CF₂)₄OCF═CF₂
CF₂═CFCF₂₀ (CF₂)₂OCF₂O—CF═CF₂
CF₂═CFCF₂₀ (CF₂)₃OCF₂O—CF═CF₂
CF₂═CFCF₂₀ (CF₂)₄OCF₂OCF═CF₂
CF₂═CFCF₂₀ (CF₂)₆OCF₂CF═CF₂
CF₂═CFO—CF₂O—(CF₂)₂O—CF₂O—CF═CF₂
CF₂═CFO—CF₂O—(CF₂)₃O—CF₂O—CF═CF₂
CF₂═CFO—CF₂O—(CF₂)₄O—CF₂O—CF═CF₂
CF₂═CFO—(CF₂O)₆—CF═CF₂
CF₂═CFO—(CF₂CF₂O)₂—CF═CF₂
CF₂═CFO—(CF₂CF₂O)₂—CF₂OCF═CF₂
CF₂═CFO(C₃F₆O)ₕ—(CF₂)ᵢ—(C₃F₆O)ⱼ—OCF═CF₂
wherein h and j are the same and
their sum is from 2 to 6 and i is from 2 to 6.

The amount of each of said at least one compound (X-p), compound (XX-p) and compound (O) is not limited. As explained above, the amount of each of the above mentioned compounds can advantageously be selected based on both the amount of the PFPE peroxy, as well as its peroxidic content, and the properties desired in the final copolymer (P).

For example, the equivalents of double bonds of said compound (X-p) to the equivalents of peroxidic groups preferably range from 1:100 to 5000:100. Also, the equivalents of double bonds of said compound (XX-p) to the equivalents of peroxidic groups preferably range from 1:100 to 100:100.

Step (a) of process (P) can be advantageously performed by contacting said PFPE peroxy with one compound of formula (X-p).

Alternatively, said step (a) can be performed by contacting said PFPE peroxy with two or more compounds of formula (X-p).

Step (a) of process (P) can be advantageously performed by contacting said PFPE peroxy with one compound of formula (XX-p).

Alternatively, said step (a) can be performed by contacting said PFPE peroxy with two or more compounds of formula (XX-p).

Step (a) and step (b) can be performed in the presence of a fluorinated solvent.

Preferably said fluorinated solvent is selected in the group comprising: perfluorocarbons, hydrofluorocarbons, perfluoropolyethers, hydrofluoro-polyethers.

Preferably, step (b) is performed in the presence of UV radiation for a time from 2 to 150 hours, more preferably from 5 to 100 hours.

Preferably, step (b) is performed in the presence of UV radiation at a temperature from −60 °C to +150 °C, more preferably from −20 °C to +100 °C and even more preferably from 0 °C to 60 °C.

As an alternative, step (b) can be performed under thermal treatment, preferably by heating at a temperature from 150 °C to 250 °C.

Preferably, said step (b) is performed in an inert atmosphere.

In a third aspect, the present invention relates to copolymer (P) obtained via process (P) as described above.

Advantageously, the functional groups introduced as pendant groups in block (3) of copolymer (P), such as notably-SO₂F, —SO₃H, —COOH, —COF, —CN, —Br and —CONH₂, as well as the functional groups at the chain ends of copolymer (P), such as notably —COF and —OC(O)F, can be properly reacted to obtain other different functional groups.

The expression “can be reacted” is intended to indicate that such functional groups can for example be salified, hydrolyzed, reduced, oxidised, or undergo a different chemical reaction to provide functional group(s) endowed with the desired reactivity, taking into consideration the final use of copolymer (P). Advantageously, copolymer (P_{F}) according to the present invention is obtained from process (P) as described above, which further comprises after said step (b), at least one step (c) comprising at least one of salification, hydrolyzation, oxidation, reduction or another chemical reaction capable of providing functional group(s) of interest.

The present invention further encompasses copolymer (P_{F}) obtained at the end of step (c) of process (P).

Hence, the present invention encompasses a block copolymer [copolymer (P_{F})] comprising a first and a second perfluoropolyether chain [PFPE chain] each having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —COOH and salts thereof with an organic cation, preferably onium cation, more preferably ammonium, or an inorganic cation, preferably an alkaline metal, more preferably Na⁺, K⁺; —COOR wherein R is a linear or branched alkyl chain comprising from 1 to 6 carbon atoms, preferably from 1 to 3 carbon atoms, more preferably 1 carbon atoms; —COF; —CONH₂; —CON(R₃₀₀)(R₃₀₁) wherein each of R₃₀₀ and R₃₀₁ have the same meanings defined for R; —(R)_{c}OH with c being 0 or 1 and R being as defined above; —C(O)—O—C(O)R with R being as defined above;
with the proviso that (i) at least one chain end of said first and second PFPE chain comprises a group different from a perfluorinated linear or branched alkyl chain having from 1 to 6 carbon atoms and (ii) when one chain end comprises group-COF, the other chain end does not comprises a perfluorinated linear or branched alkyl chain having from 1 to 6 carbon atoms or —COF;
and the second chain ends of said first and second PFPE chain are bonded to each other via:
   at least one first block [block (1)] complying with formula (I):

[CR₁₀₀R₁₀₁—CR₁₀₂R₁₀₃]_{L\hat{ }}-(D)L- (I)
wherein
L\hat{ }, L, D, R₁₀₀, R₁₀₁, R₁₀₂ and R₁₀₃ have the meanings defined above;
at least one second block [block (2)] complying with formula (II):

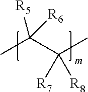

wherein
m, R₅ to R₈, have the meanings defined above;
at least one third block [block (3)] complying with formula (IV):

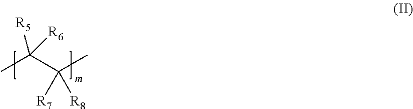

wherein
n, R₁ to R₄, have the meanings defined above;
and
   optionally, at least one fourth block [block (4)] comprising a PFPE chain;
with the proviso that, in copolymer (P_{F}):
   the sum of (L+L\hat{ }+e\hat{ }+e*) is at least 1, preferably from 1 to 500, more preferably from 2 to 500, more preferably from 2 to 300;
   the sum of (m+f) is at least 1, preferably from 1 to 100;
   the sum of (n+b) is at least 1, preferably from 1 to 15, more preferably from 1 to 11, even more preferably from 1 to 9; and
   said at least one block (1), said at least one block (2), said at least one block (3) and, when present, said at least one block (4) are statistically distributed.

In another aspect, the present invention relates to a mixture [mixture (P_{F})] comprising two or more copolymers (P_{F}) as defined above.

While purification steps can be performed after any of step (b) and/or step (c) of said process (P), mixtures of copolymers (P) or copolymers (P_{F}) according to the present invention are typically obtained.

Thus, in a further aspect, the present invention relates to a mixture [mixture (P)] comprising two or more copolymers (P) as defined above.

It will be clear to those skilled in the art that mixture (P) is obtained via process (P) as described above.

Advantageously, said mixture (P) can be subjected to one or more purification steps (also referred to as “fractionation” steps), thus obtaining separate copolymers (P) characterised by different viscosities and/or number average molecular weights as measured by ¹⁹F-NMR and/or functionality (F), preferably from 3 to 102.

Said mixtures can further contain the PFPE peroxy used as starting material and/or mixtures of copolymers (P) containing peroxy groups [copolymer (P_{O—O})] and/or mixtures of copolymers (P_{F}) containing peroxy groups [copolymers (P_{F—O—O})] can be obtained.

In another aspect, the present invention related to a mixture [mixture (M1)] comprising at least one copolymer (P) as defined above, and at least one of said PFPE peroxy used as starting material and/or one or more of copolymers (P_{O—O}). In another aspect, the present invention relates to a mixture [mixture (M2)] comprising at least one copolymer (P_{F}) as defined above, and at least one of at least one of copolymer (P) as defined above, said PFPE peroxy used as starting material, said one or more copolymers (P_{O—O}), and/or said one or more copolymers (P_{F—O—O}).

Advantageously, copolymer (P_{O—O}) and/or copolymer (P_{F—O—O}) can be isolated and used as intermediate in other processes.

While the amount of peroxy groups that can be present in the mixture containing copolymer (P) or copolymer (P_{F}) of the present invention can be up to 99% based on the amount of the starting peroxy groups in the PFPE peroxy, depending on the final application the amount of said peroxy groups can be properly adjusted for example up to 95, 90, 85, 80, 75, 70, 65, 60, 55, 50, 45, 40, 35, 30, 25, 20, 15, 10, 5%.

More preferably, the amount of said peroxy groups is up to 1, even more preferably up to 0.5% and still more preferably up to 0.1%.

In another aspect, the present invention relates to a block copolymer [copolymer (P_{O—O})] comprising a first and a second perfluoropolyether chain [PFPE chain], wherein each of said first and second PFPE chain is a chain (R_{f}) as defined above or is a chain (Rf_{O—O}) wherein (Rf_{O—O}) is a repeating units complying with any one of formulae (i) to (v) as defined above for (R°) and having a peroxidic content (PO), defined as grams of active oxygen (Mw=16) in 100 g of PFPE peroxy between 0.1 and 4, preferably between 0.1 and 3.5, each of said first and second PFPE chain having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —C(═O)F and —OC(═O)F; and the second chain ends of said first and second PFPE chain are bonded to each other via:
at least one first block [block (1)] complying with formula (I) as defined above;
at least one second block [block (2)] complying with formula (II) as defined above;
at least one third block [block (3)] complying with formula (IV) as defined above; and/or
optionally, at least one fourth block [block (4)] comprising a PFPE chain as defined above;
with the proviso that
   in copolymer (P_{O—O})
said block (1), said block (2), said block (3) and, when present, said at least one block (4) are statistically distributed,
the sum of (n+b) is at least 1, preferably from 1 to 15, more preferably from 1 to 11, even more preferably from 1 to 9;
the sum of (L+L\hat{ }+e\hat{ }+e*) is at least 1, preferably from 1 to 500, more preferably from 2 to 500, more preferably from 2 to 300;
the sum of (m+f) is at least 1, preferably from 1 to 100.

In a still another embodiment, the present invention relates to a block copolymer [copolymer (P_{F—O—O})] comprising a first and a second perfluoropolyether chain [PFPE chain], wherein each of said first and second PFPE chain is a chain (R_{f}) as defined above or is a chain (Rf_{O—O}) wherein (Rf_{O—O}) is a repeating units complying with any one of formulae (i) to (v) as defined above for (R°) and having a peroxidic content (PO), defined as grams of active oxygen (Mw=16) in 100 g of PFPE peroxy between 0.1 and 4, preferably between 0.1 and 3.5, each of said first and second PFPE chain having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —COOH and salts thereof with an organic cation, preferably onium cation, more preferably ammonium, or an inorganic cation, preferably an alkaline metal, more preferably Na⁺, K⁺; —COOR with R being as defined above; —COF; —CON(R₃₀₀)(R₃₀₁) wherein each of R₃₀₀ and R₃₀₁ are a hydrogen atom or have the same meanings defined for R; —(R)_{c}OH with c being 0 or 1 and R being as defined above; —C(O)—O—C(O)R with R being as defined above; —Br; —CN₂; and the second chain ends of said first and second PFPE chain are bonded to each other via:
at least one first block [block (1)] complying with formula (I) as defined above;
at least one second block [block (2)] complying with formula (II) as defined above;
at least one third block [block (3)] complying with formula (IV) as defined above; and/or
optionally, at least one fourth block [block (4)] comprising a PFPE chain as defined above;
with the proviso that
   in copolymer (P_{F—O—O})
said block (1), said block (2), said block (3) and, when present, said at least one block (4) are statistically distributed,
the sum of (n+b) is at least 1, preferably from 1 to 15, more preferably from 1 to 11, even more preferably from 1 to 9;
the sum of (L+L\hat{ }+e\hat{ }+e*) is at least 1, preferably from 1 to 500, more preferably from 2 to 500, more preferably from 2 to 300;
the sum of (m+f) is at least 1, preferably from 1 to 100.

Copolymer (P) and/or copolymer (P_{F}) according to the present invention can be used for different applications in several industries, wherein outstanding resistance and durability at high temperature and harsh environments is required. For example, copolymer (P) and/or copolymer (P_{F}) can be used as base oils as lubricants. Alternatively, copolymer (P) and/or copolymer (P_{F}) can be used as additives in halogenated oils and/or greases.

To this aim and advantageously, the copolymers according to the present invention as well as the mixtures described herein, are in the liquid state at room temperature, or even at temperatures lower than room temperature, with advantages in handling and storage of the copolymers.

Hence, advantageously, copolymer (P) is in the liquid state at room temperature.

Also, advantageously, copolymer (P_{F}) is in the liquid state at room temperature.

In addition, each of copolymer (P_{O—O}) and copolymer (P_{F—O—O}) as well as each of mixture (M1) and mixture (M2) is in the liquid state at room temperature.

Should the disclosure of any patents, patent applications, and publications which are incorporated herein by reference conflict with the description of the present application to the extent that it may render a term unclear, the present description shall take precedence.

The invention will be hereinafter illustrated in greater detail by means of the Examples contained in the following Experimental Section; the Examples are merely illustrative and are by no means to be interpreted as limiting the scope of the invention.

### Experimental Section

### Materials

Peroxidic perfluoropolyether oil was obtained by Solvay Specialty Polymers Italy S.p.A., complying with formula

XO—(CF₂CF₂O)ₐ₁(CF₂O)ₐ₂(O)ₕ—X′
wherein
X and X′ were-CF₃, —CF₂COF, —COF and having the following properties:
Mn=31 990 g/mol; P.O.=1.61%; a1/a2=1.0

The following were purchased by Anles LTD and used as such: (8CNVE) CF₂═CFOCF₂CF(CF₃)OCF₂CF₂CN (PBVE) CF₂═CFOCF₂CF₂CF₂OCF═CF₂

Perfluorinated solvents Galden (R) HT200 and Galden (R) D100, as well as tetrafluoroethylene (TFE) and perfluoro-methylvinyl-ether (PMVE), and perfluorinated sulfonyl vinyl ether (VEFS)CF₂═CFOCF₂CF₂SO₂F were obtained by Solvay Specialty Polymers Italy S.p.A.

### Methods:

¹⁹F-NMR-Varian Mercury 300 MHz spectrometer working for the ¹⁹F nucleus was used to obtain the structure, molecular weight, chain end composition of the perfluoropolyether oils. The ¹⁹F-NMR spectrum was obtained on pure samples using CFCl₃ as internal reference.

The peroxidic content (PO) was expressed as grams of peroxidic oxygen per 100 g of polymer. The analysis of the peroxide content was carried out by iodometric titration using a Mettler DL40 device equipped with platinum electrode. The sensitivity limit for the PO determination was 0.0002%.

GPC analyses were performed on a Waters GPC equipped with an RI detector and operating at 35 °C. All average molecular weight results are reported compared to perfluoropolyethers linear neutral internal standards.

The complex viscosity was measured by means of frequency sweep tests, using an MCR502 Anton-Paar rheometer with parallel plate geometry (25 mm diameter). The viscosity was measured in this way at 25 °C and 100 °C and its value at 0.1 rad/s of oscillation is reported.

### Example 1—PFPE Copolymer with VEFS, TFE, PMVE and PBVE

250.3 g of the peroxidic perfluoropolyether oil described above were charged in a 1500 mL stirred cylindrical photochemical reactor equipped with a high pressure mercury lamp model HANAU TQ150, a thermocouple, a condenser and a mechanical stirrer.

The oil was diluted with 1876 g of Galden (R) HT200 and then 23.0 g of VEFS and 1.1 g of PBVE were added to the reactor.

The mixture was then purged with nitrogen under stirring, after which two fluorinated olefins, PMVE and TFE, were introduced into the reactor, at a rate of 14.6 and 8.0 g/h, respectively. After the flow started, the UV lamp was switched on and the reaction was conducted at 20 °C for 7 h. After this time the olefin flows were interrupted, the UV lamp was switched off.

The obtained solution was distilled at 240 °C for 4 h in a round bottom flask equipped with a magnetic stirrer in order to remove the solvent and unreacted monomer traces. The distillation was conducted first at atmospheric pressure, then under reduced pressure (0.1 mbar) until complete removal of the solvent.

298.0 g of copolymer in the form of a clear viscous oil were obtained as residue, which was analysed by iodometric titration to confirm the complete removal of the peroxide units.

¹⁹F-NMR analysis confirmed the absence of residual peroxide units.

The incorporation of VEFS, TFE and MVE in the copolymer was at a concentration respectively of 5.3, 13.9 and 9.8 weight %.

The copolymer had a1/a2=0.9 and X and X′═—CF₃, —CF₂COF and —OCOF.

### Example 2—PFPE Copolymers with 8CNVE, PBVE, TFE and PMVE

251.8 g of the peroxidic perfluoropolyether oil described above were charged in the same reactor as Example 1. The oil was diluted with 1873 g of Galden (R) D100. Next, 29.2 g of 8CNVE and 2.5 g of PBVE were added to the reactor.

The mixture was then purged with nitrogen under stirring, after which two fluorinated olefins, PMVE and TFE, were introduced into the reactor, at a rate of 17.1 and 9.3 g/h, respectively. After the flow started, the UV lamp was switched on and the reaction was conducted at 20 °C for 6 h. After this time the olefin flows were interrupted and the UV lamp was kept on for further 35 hours at 20 °C.

After a total of 35 hours of UV irradiation, the lamp was switched off and the reaction mixture was transferred into a 2-L round bottom flask. The mixture was stripped at 120 °C for 6 h under reduced pressure (0.1 mbar) until complete removal of the solvent and unreacted monomer traces.

271.4 g of copolymer in the form of a clear viscous oil were obtained as residue.

¹⁹F-NMR analysis confirmed the incorporation of 8CNVE, TFE and MVE in the copolymer at a concentration respectively of 7.0, 14.2 and 9.6 weight %.

The copolymer had a1/a2=0.9 and X and X′═—CF₃, —CF₂COF and —OCOF.

The introduction of the —CN functional groups was also confirmed by FT-IR spectroscopy measurements, confirming the presence of the peak at 2269 cm⁻¹.

### Comparative Example 1—PFPE Copolymers with VEFS, TFE and PMVE

251 g of the peroxidic perfluoropolyether oil described above were charged in a the same reactor as Example 1. The oil was diluted with 1876 g of a perfluorinated solvent, Galden (R) HT200, and 14.0 g of VEFS were added to the reactor.

The mixture was then purged with nitrogen under stirring, after which two fluorinated olefins, PMVE and TFE, were introduced into the reactor, at a rate of 14.6 and 8.0 g/h, respectively. After the flow started, the UV lamp was switched on and the reaction was conducted at 20 °C for 7 h. After this time, the olefin flows were interrupted, the UV lamp was switched off

The obtained solution was distilled at 240 °C for 4 h in a round bottom flask equipped with a magnetic stirrer in order to remove the solvent and unreacted monomer traces. The distillation was conducted first at atmospheric pressure, then under reduced pressure (0.1 mbar) until complete removal of the solvent.

275.1 g of copolymer in the form of a clear viscous oil were obtained as residue, which was analysed by iodometric titration to confirm the complete removal of the peroxide units.

¹⁹F-NMR analysis confirmed the incorporation of VEFS, TFE and PMVE in the copolymer at a concentration respectively of 3.8, 13.4 and 9.6 weight %.

The copolymer had Mn=35600 g/mol, a1/a2=0.9 and X and X′═—CF₃, —CF₂COF and —OCOF.

### Comparative Example 2—PFPE Copolymers with 8CNVE, TFE and PMVE

250 g of the peroxidic perfluoropolyether oil described above were charged in the same reactor as Example 1. The oil was diluted with 1875 g of a perfluorinated solvent, Galden (R) D100, and 29.2 g of 8CNVE were added to the reactor.

The mixture was then purged with nitrogen under stirring, after which two fluorinated olefins, PMVE and TFE, were introduced into the reactor, at a rate of 17.1 and 9.3 g/h, respectively. After the flow started, the UV lamp was switched on and the reaction was conducted at 20 °C for 6 h. After this time the olefin flows were interrupted and the UV lamp was kept on for further 35 hours at 20 °C.

After a total of 35 hours of UV irradiation, the lamp was switched off and the reaction mixture was transferred into a 2-L round bottom flask. The mixture was stripped at 120 °C for 6 h under reduced pressure (0.1 mbar) until complete removal of the solvent and unreacted monomer traces.

265 g of copolymer in the form of a clear viscous oil were obtained as residue.

¹⁹F-NMR analysis of the product confirmed the incorporation of 8CNVE, TFE and PMVE in the copolymer at a concentration respectively of 7.3, 12.0 and 11.4 weight %.

The copolymer had: Mn=35000 g/mol, a1/a2=0.9, and X and X′═—CF₃, —CF₂COF and —OCOF.

The properties of the copolymers according to the invention and of comparison are summarised in Table 1 below.

TABLE 1

| | | | Complex viscosity | Complex viscosity |
|---|---|---|---|---|
| | Mw | | (@0.1 rad/s and | @ 0.1 rad/s and |
| | (g/mol) | Mw/Mn | 25 °C) Pa*s | 100 °C (Pa/s) |
| Example 1 | 144 400 | 7.4 | 62.2 | 4.0 |
| Comp 1(*) | 77 200 | 3.6 | 21.7 | 2.0 |
| Example 2 | n/p | n/p | 78.5 | 4.5 |
| Comp 2(*) | n/p | n/p | 38.1 | 2.8 |

(*)comparative
n/p = not performed

1. A block copolymer, copolymer (P), comprising a first and a second perfluoropolyether chain, PFPE chain, each having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —C(═O)F and —OC(═O)F, and the second chain ends of said first and second PFPE chain are bonded to each other via:
at least one first block, block (1), complying with formula (I):
—[CR₁₀₀R₁₀₁—CR₁₀₂R₁₀₃]_{L\hat{ }}-(D)L- (I)
wherein
L\hat{ } is 0 or an integer from 1 to 250;
R₁₀₀, R₁₀₁, R₁₀₂ and R₁₀₃ are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms;
L is 0 or an integer from 1 to 250, and
D is a group of formula —(CR_{100*}R_{101*}—CR_{102*}R_{103*})— wherein at least one of R_{100*}, R_{101*}R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—;
with the proviso that, when L\hat{ } and L are both different from 0, the recurring units are statistically distributed;
at least one second block, block (2), complying with formula (II): 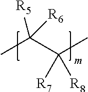
wherein
m is 0 or an integer from 1 to 5;
R₅ to R₈, each independently, is selected from the group consisting of —F, perfluorinated linear or branched alkyl chain having from 1 to 6 carbon atoms, and group of formula (III):
—R₂₀—(X)_{y} (III)
wherein
R₂₀ is a sigma bond, or linear or branched perfluoroalkyl chain comprising from 1 to 12 carbon atoms, optionally comprising and/or interrupted by at least one oxygen atom,
X is a functional group; and
y is an integer equal to 1 or 2;
with the proviso that in formula (II), at least one of R₅ to R₈ is group of formula (III);
at least one third block, block (3), complying with formula (IV): 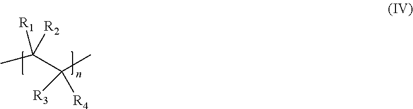
wherein
n is an integer from 1 to 3;
R₁ to R₄, each independently, is selected from the group consisting of fluorine atom, perfluorinated linear or branched alkyl group having from 1 to 6 carbon atoms, group of formula (V):
—(R₁₀)ₜ[C(R₁₁)(R₁₂)—C(R₁₃)(R₁₄)(R₁₅)]_{z} (V)
wherein
R₁₀ is an oxygen atom, or a bi-/tri-/tetravalent perfluorinated alkyl chain comprising from 1 to 24 carbon atoms and being optionally interrupted by at least one oxygen atom,
t is zero or 1,
z is an integer from 1 to 3,
R₁₁ to R₁₅, each independently, is selected from the group consisting of: fluorine atom, perfluorinated linear or branched alkyl group having from 1 to 6 carbon atoms and group of formula (VI):
-[(A)ₐ-(B)_{b}-(E)-(F)_{f}]ᵤ-(A)-T (VI)
wherein
u is zero or an integer from 1 to 50;
T is a perfluorinated alkyl group;
a is zero or 1,
each A is a PFPE chain;
b is zero or an integer from 1 to 3,
B is a block of formula (IV*):
—[C(R_{1\hat{ }})(R_{2\hat{ }})—C(R_{3\hat{ }})(R_{4\hat{ }})]— (IV*)
wherein
R_{1\hat{ }} to R_{4\hat{ }} each independently has the meaning defined above for each of R₁ to R₄, respectively;
E is a block of formula (I*)
—[CR_{100\hat{ }}R_{101\hat{ }}—CR_{102\hat{ }}R_{103\hat{ }}]_{e\hat{ }}-(D*)_{e*}- (I*)
wherein
e\hat{ } is 0 or an integer from 1 to 250,
each of R₁₀₀R_{101\hat{ }},R_{102\hat{ }} and R_{103\hat{ }} are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀R_{101\hat{ }},R_{102\hat{ }} and R_{103\hat{ }} are a fluorine atom and the other of R₁₀₀ and R₁₀₁ and the other of R₁₀₂ and R₁₀₃ together form a perhalogenated cyclic ring having from 4 to 6 members, optionally comprising heteroatoms,
e* is 0 or an integer from 1 to 250, and
D* is a group of formula —(CR_{100*}R_{101*}—CR_{102*}R_{103*})— wherein at least one of R_{100*}, R_{101*}R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—,
with the proviso that, when e\hat{ } and e* are both different from 0, the recurring units are statistically distributed;
f is 0 or an integer from 1 to 5, preferably from 1 to 2;
F is a block of formula (II*):
—[C(R_{5\hat{ }})(R_{6\hat{ }})—C(R_{7\hat{ }})(R_{8\hat{ }})]—
wherein
R_{5\hat{ }} to R_{8\hat{ }}, each independently, is selected from the group consisting of —F, perfluorinated linear or branched alkyl chain having from 1 to 6 carbon atoms, and group of formula (III):
—R₂₀—(X)_{y} (III)
wherein
R₂₀ is a sigma bond, or linear or branched perfluoroalkyl chain comprising from 1 to 12 carbon atoms, optionally comprising and/or interrupted by at least one oxygen atom,
X is a functional group; and
y is an integer equal to 1 or 2;
with the proviso that in formula (II), at least one of R₅ to R₈ is group of formula (III);
with the proviso that:
in said formula (IV), at least one of R₁ to R₄ is a group of formula (V),
in said formula (IV*), at least one of R_{1\hat{ }} to R_{4\hat{ }} is a group of formula (V)
in said formula (V), one of R₁₁ or R₁₂ and one of R₁₃ to R₁₅, is a group of formula (VI),
in said formula (VI), the recurring units (A), (B), (E) and (F) are statistically distributed;
and
optionally, at least one fourth block, block (4), comprising a PFPE chain;
with the proviso that, in copolymer (P):
the sum of (L+L\hat{ }+e\hat{ }+e*) is at least 1;
the sum of (m+f) is at least 1;
the sum of (n+b) is at least 1; and
said at least one block (1), said at least one block (2), said at least one block (3) and, when present, said at least one block (4) are statistically distributed.

2. The copolymer (P) according to claim 1, wherein each of said PFPE chain is a fully fluorinated chain, chain (R_{f}), comprising repeating units R°, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

3. The copolymer (P) according to claim 2, wherein said chain (R_{f}) complies with the following formula:
—[(CFX¹O)_{g1}(CFX²CFX³⁰)_{g2}(CF₂CF₂CF₂O)_{g3}(CF₂CF₂CF₂CF₂O)_{g4}]— (R_{f}-I)
wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100;
should at least two of g1, g2, g3 and g4 be different from zero, the different recurring units are generally statistically distributed along the chain.

4. The copolymer (P) according to claim 1, wherein in said block (1):
at least one of L\hat{ } and L is different from 0; and/or
R₁₀₀, R₁₀₁, R₁₀₂ and R₁₀₃, each independently, is a halogen atom.

5. The copolymer (P) according to claim 1, wherein in said block (2):
m is 0 or an integer from 1 to 2;
one of R₅ to R₈ is a group of formula (V)ⱼ and/or
R₂₀ is a sigma bond or a group selected from those of formula (R₂₀-i) to (R₂₀-iv):
—(CF₂)ₛ₁—O—(CF₂)ₛ₂— (R₂₀-i)
wherein each of s1 and s2 is independently an integer from 1 to 6, preferably from 1 to 3;
—O—(CF₂)ₛ₃— (R₂₀-ii)
wherein s3 is an integer from 1 to 6, preferably from 1 to 5;
—O—R₄₀₀—O—R₄₀₁— (R₂₀-iii)
wherein
R₄₀₀ is a linear or branched perfluorinated alkyl chain comprising from 1 to 6 carbon atoms; and
R₄₀₁ is a linear or branched perfluorinated alkyl chain comprising from 1 to 3 carbon atoms; 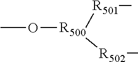
wherein
R₅₀₀ is a linear perfluorinated alkyl chain comprising from 1 to 6 carbon atoms and optionally interrupted by at least one oxygen atom;
R₅₀₁ is a chain of formula —OR₅₀₃ wherein R₅₀₃ is a linear perfluorinated alkyl chain comprising from 1 to 3 carbon atoms;
R₅₀₂ is a linear perfluorinated alkyl chain comprising from 1 to 4 carbon atoms and optionally interrupted by at least one oxygen atom;
each of R₅₀₁ and R₅₀₂ bonding a group X, wherein X is a functional group.

6. The copolymer (P) according to claim 1, wherein in said block (3) and formula (V), R₁₀ complies with one of the following formulae:
—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and R_{CF} is a perfluoroalkyl chain comprising from 1 to 12, optionally interrupted by one or more oxygen atoms
—O—(C₃F₆O)ₕ—(CF₂)ᵢ—(C₃F₆O)ⱼ—O— (R₁₀-ii)
wherein
h=j and h+j is from 2 to 6, and i is from 2 to 6.

7. A process, process (P), for the manufacture of copolymer (P) according to claim 1, said process (P) comprising the steps of:
(a) contacting:
at least one perfluoropolyether polymer comprising at least one peroxidic group, PFPE peroxy;
at least one compound, compound (O), selected from the group consisting of:
(i) fully halogenated olefin comprising from 2 to 15 carbon atoms;
(ii) CF₂═CFOR_{f},
wherein
R_{f} is a C₁-C₆ (per)fluoroalkyl group; a group C₁-C₁₂ [(per)fluoro]-oxyalkyl comprising catenary oxygen atoms;
(iii) CF₂═CFOCF₂OR_{f2}
wherein
R_{f2} is selected from the group consisting of C₁-C₆ perfluoro-alkyls; C₅-C₆ cyclic perfluoro-alkyls, and C₂-C₆ perfluoro-Oxy-alkyls, comprising at least one catenary oxygen atom;
(iv) CF₂═CFCF₂OR_{f7}
wherein
R_{f7} is selected from the group consisting of C₁-C₆ perfluoro-alkyls, C₅-C₆ cyclic perfluoro-alkyls, and C₂-C₆ perfluoro-oxy-alkyls, comprising at least one catenary oxygen atom;
(vi) perfluorodioxoles having formula: 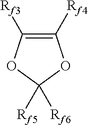
wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom;
at least one perfluorinated compound of formula (X-p): 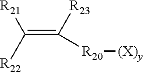
wherein
each of R₂₁ to R₂₃ is independently —F or perfluorinated linear or branched alkyl chain having from 1 to 6 carbon atoms,
R₂₀ is a sigma bond or a group selected from those of formula (R₂₀-i) to (R₂₀-iv):
—(CF₂)ₛ₁—O—(CF₂)ₛ₂— (R₂₀₋₁)
wherein each of s1 and s2 is independently an integer from 1 to 6;
—O—(CF₂)ₛ₃— (R₂₀-ii)
wherein s3 is an integer from 1 to 6;
—O—R₄₀₀—O—R₄₀₁— (R₂₀-iii)
wherein
R₄₀₀ is a linear or branched perfluorinated alkyl chain comprising from 1 to 6 carbon atoms; and
R401 is a linear or branched perfluorinated alkyl chain comprising from 1 to 3 carbon atoms; 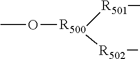
wherein
R₅₀₀ is a linear perfluorinated alkyl chain comprising from 1 to 6 carbon atoms and optionally interrupted by at least one oxygen atom;
R₅₀₁ is a chain of formula —OR₅₀₃ wherein R₅₀₃ is a linear perfluorinated alkyl chain comprising from 1 to 3 carbon atoms;
R₅₀₂ is a linear perfluorinated alkyl chain comprising from 1 to 4 carbon atoms and optionally interrupted by at least one oxygen atom;
each of R₅₀₁ and R₅₀₂ bonding a group X,
wherein X is a functional group, and y is an integer equal to 1 or 2;
at least one perfluorinated compound of formula (XX-p): 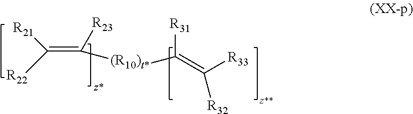
wherein
each of R₂₁ to R₂₃ are as defined above in formula (X-p),
each of R₃₁ to R₃₃ is independently —F or perfluorinated alkyl group having from 1 to 6 carbon atoms,
R₁₀ is an oxygen atom, a perfluorinated alkyl chain comprising from 1 to 24 carbon atoms, optionally interrupted by at least one oxygen atom,
t is zero or 1;
each of z* and z** is independently 1 or 2; and
(b) reacting said PFPE peroxy, said at least one compound of formula (X-p), said at least one compound of formula (XX-p) and at least one compound (O) in the presence of UV radiation or under heating.

8. The process (P) according to claim 7, wherein process (P) comprises before step (a), a step of subjecting the PFPE peroxy to partial reduction of the peroxide bonds.

9. The process (P) according to claim 7, wherein said PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (Rf), comprising repeating units (R°) and having a peroxidic content (PO), defined as grams of active oxygen (Mw=16) in 100 g of PFPE peroxy between 0.1 and 4, preferably between 0.1 and 3.5, and
wherein
repeating units R° are independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is —F;
(iii) CF₂CF₂CF₂O—;
(iv) —CF₂CF₂CF₂CF₂O—;
—(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently —For —CF₃ and T being a C₁-C₃ perfluoroalkyl alkyl chain.

10. The process (P) according to claim 7, wherein said process (P) is performed:
with at least one compound (O) selected from the group consisting of fully halogenated olefin comprising from 2 to 10 carbon atoms; and/or
with at least two compounds (O), wherein the first compound (O) is selected from the group consisting of fully halogenated olefin comprising from
2 to 15 carbon atoms, and the second compound (O) is selected from the group consisting of:
CF₂═CFOR_{f}, (ii)
wherein
R_{f} is a C₁-C₆ (per)fluoroalkyl group; a group C₁-C₁₂ [(per)fluoro]-oxyalkyl comprising catenary oxygen atoms;
CF₂═CFOCF₂OR_{f2} (iii)
wherein
R_{f7} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom;
CF₂═CFCF₂OR_{f7} (iv)
wherein
R_{f7} is selected from the group consisting of C₁-C₆ perfluoro-alkyls, C₅-C₆ cyclic perfluoro-alkyls, and C₂-C₆ perfluoro-oxy-alkyls, comprising at least one catenary oxygen atom;
(v) perfluorodioxoles having formula: 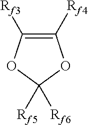
wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom.

11. The process (P) according to claim 7, wherein in said compound (X-p), R₂₀ is a sigma bond or a group selected from those of formula (R₂₀-i) to (R₂₀-iv) as defined hereinafter:
—(CF₂)ₛ₁—O—(CF₂)ₛ₂— (R₂₀-i)
wherein each of s1 and s2 is independently an integer from 1 to 6, preferably from 1 to 3;
—O—(CF₂)ₛ₃— (R₂₀-ii)
wherein s3 is an integer from 1 to 6, preferably from 1 to 5;
—O—R₄₀₀—O—R₄₀₁— (R₂₀-iii)
wherein
R₄₀₀ is a linear or branched perfluorinated alkyl chain comprising from 1 to 6 carbon atoms; and
R₄₀₁ is a linear or branched perfluorinated alkyl chain comprising from 1 to 3 carbon atoms; 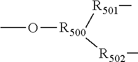
wherein
R₅₀₀ is a linear perfluorinated alkyl chain comprising from 1 to 6 carbon atoms and optionally interrupted by at least one oxygen atom;
R₅₀₁ is a chain of formula —OR₅₀₃ wherein R₅₀₃ is a linear perfluorinated alkyl chain comprising from 1 to 3 carbon atoms;
R₅₀₂ is a linear perfluorinated alkyl chain comprising from 1 to 4 carbon atoms and optionally interrupted by at least one oxygen atom;
each of R₅₀₁ and R₅₀₂ bonding a group X, wherein X is a functional group.

12. The process (P) according to claim 7, wherein said compound of formula (XX-p) complies with formula
CF₂═CF(R₁₀)ₜCF═CF₂
wherein t is zero or 1, and
R₁₀ complies with one of the following formulae:
—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and RCF is a perfluoroalkyl chain comprising from 1 to 12, optionally interrupted by one or more oxygen atoms
—O—(C₃F₆O)ₕ—(CF₂)ᵢ—(C₃F₆O)ⱼ—O— (R₁₀-ii)
wherein h=j and h+j is from 2 to 6, and i is from 2 to 6.

13. The process (P) according to claim 7, wherein:
step (a) and step (b) are performed in the presence of a fluorinated solvent; and/or
step (b) is performed
in the presence of UV radiation for a time from 2 to 150 hours;
in the presence of UV radiation at a temperature from −60 °C to +150 °C;
under thermal treatment at a temperature from 150 °C to 250 °C;
under inert atmosphere.

14. A block copolymer, copolymer (P_{F}), comprising a first and a second perfluoropolyether chain, PFPE chain, each having two chain ends, wherein the first chain end of each one of said first and second PFPE chain is a chain end of the copolymer and each one comprises a group selected from a perfluorinated linear or branched alkyl chain comprising from 1 to 6 carbon atoms, —COOH and salts thereof with an organic cation, or an inorganic cation; —COOR wherein R is a linear or branched alkyl chain comprising from 1 to 6 carbon atoms; —COF; —CONH₂; —CON(R₃₀₀)(R₃₀₁) wherein each of R₃₀₀ and R₃₀₁ is a linear or branched alkyl chain comprising from 1 to 6 carbon atoms; —(R)_{c}OH with c being 0 or 1 and R is a linear or branched alkyl chain comprising from 1 to 6 carbon atoms; —C(O)—O—C(O)R with R being a linear or branched alkyl chain comprising from 1 to 6 carbon atoms;
with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprise a perfluorinated linear or branched alkyl chain having from 1 to 6 carbon atoms or —COF;
and the second chain ends of said first and second PFPE chain are bonded to each other via:
at least one first block [block (1)] complying with formula (I):
—[CR₁₀₀R₁₀₁—CR₁₀₂R₁₀₃]_{L\hat{ }}-(D)L- (I)
Wherein
L\hat{ } is 0 or an integer from 1 to 250,
L is 0 or an integer from 1 to 250,
D is a group of formula —(CR_{100*}R_{101*}—CR_{102*}R_{103*})— wherein at least one of R_{100*}, R_{101*} R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—;
with the proviso that, when L\hat{ } and L are both different from 0, the recurring units are statistically distributed,
R₁₀₀, R₁₀₁, R₁₀₂ and R₁₀₃ are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms;
at least one second block, block (2), complying with formula (II): 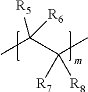
wherein
m is 0 or an integer from 1 to 5;
R₅ to R₈, each independently, is selected in the group comprising, preferably consisting of, —F, perfluorinated linear or branched alkyl chain having from 1 to 6 carbon atoms, and group of formula (III):
—R₂₀—(X)_{y} (III)
wherein
R₂₀ is a sigma bond, or linear or branched perfluoroalkyl chain comprising from 1 to 12 carbon atoms, preferably comprising and/or interrupted by at least one oxygen atom,
X is a functional group; and
y is an integer equal to 1 or 2;
with the proviso that in formula (II), at least one, preferably one, of R₅ to R₈ is group of formula (III);
at least one third block, block (3), complying with formula (IV): 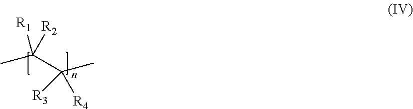
wherein
n is an integer from 1 to 3;
R₁ to R₄, each independently, is selected from the group consisting of fluorine atom, perfluorinated linear or branched alkyl group having from 1 to 6 carbon atoms, group of formula (V):
—(R₁₀)ₜ[C(R₁₁)(R₁₂)—C(R₁₃)(R₁₄)(R₁₅)]_{z} (V)
wherein
R₁₀ is an oxygen atom, or a bi-/tri-/tetravalent perfluorinated alkyl chain comprising from 1 to 24 carbon atoms and being optionally interrupted by at least one oxygen atom,
t is zero or 1,
z is an integer from 1 to 3,
R₁₁ to R₁₅, each independently, is selected from the group consisting of: fluorine atom, perfluorinated linear or branched alkyl group having from 1 to 6 carbon atoms and group of formula (VI):
-[(A)ₐ-(B)_{b}-(E)-(F)_{f}]ᵤ-(A)-T (VI)
wherein
u is zero or an integer from 1 to 50;
T is a perfluorinated alkyl group;
a is zero or 1,
each A is a PFPE chain;
b is zero or an integer from 1 to 3,
B is a block of formula (IV*):
—[C(R_{1\hat{ }})(R_{2\hat{ }})—C(R_{3\hat{ }})(R_{4\hat{ }})]— (IV*)
wherein
R_{1\hat{ }} to R_{4\hat{ }} each independently has the meaning defined above for each of R₁ to R₄, respectively;
E is a block of formula (I*)
—[CR_{100\hat{ }}R_{101\hat{ }}—CR_{102\hat{ }}R_{103\hat{ }}]_{e\hat{ }}A-(D*)_{e*}- (I*)
wherein
e\hat{ } is 0 or an integer from 1 to 250,
each of R₁₀₀R_{101\hat{ }},R_{102\hat{ }} and R_{103\hat{ }} are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀R_{101\hat{ }},R_{102\hat{ }} and R_{103\hat{ }} are a fluorine atom and the other of R₁₀₀ and R₁₀₁ and the other of R₁₀₂ and R₁₀₃ together form a perhalogenated cyclic ring having from 4 to 6 members, optionally comprising heteroatoms,
e* is 0 or an integer from 1 to 250, and
D* is a group of formula —(CR_{100*}R_{101*}—CR_{102*}R_{103*})— wherein at least one of R_{100*}, R_{101*} R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—,
with the proviso that, when e\hat{ } and e* are both different from 0, the recurring units are statistically distributed;
f is 0 or an integer from 1 to 5;
F is a block of formula (II*):
—[C(R_{5\hat{ }})(R_{6\hat{ }})—C(R_{7\hat{ }})(R_{8\hat{ }})]—
wherein
R_{5\hat{ }} to Ros, each independently, is selected from the group consisting of —F, perfluorinated linear or branched alkyl chain having from 1 to 6 carbon atoms, and group of formula (III):
—R₂₀—X) (III)
wherein
R₂₀ is a sigma bond, or linear or branched perfluoroalkyl chain comprising from 1 to 12 carbon atoms, optionally comprising and/or interrupted by at least one oxygen atom,
X is a functional group; and
y is an integer equal to 1 or 2;
with the proviso that in formula (II), at least one of R₅ to R₈ is group of formula (III);
with the proviso that:
in said formula (IV), at least one of R₁ to R₄ is a group of formula (V),
in said formula (IV*), at least one of R_{1\hat{ }} is to R_{4\hat{ }} is a group of formula (V)
in said formula (V), one of R₁ or R₁₂ and one of R₁₃ to R₁₅, is a group of formula (VI),
in said formula (VI), the recurring units (A), (B), (E) and (F) are statistically distributed; and
optionally, at least one fourth block, block (4), comprising a PFPE chain;
with the proviso that, in copolymer (P_{F}):
the sum of (L+L\hat{ }+e\hat{ }+e*) is at least 1;
the sum of (m+f) is at least 1;
the sum of (n+b) is at least 1; and
said at least one block (1), said at least one block (2), said at least one block (3) and, when present, said at least one block (4) are statistically distributed.

15. A block copolymer, copolymer (P_{O—O}), comprising a first and a second perfluoropolyether chain, PFPE chain, wherein each of said first and second PFPE chain is a chain (Rf) or is a chain (Rf_{O—O}) wherein (Rf_{O—O}) is a repeating units complying with any one of formulae (i) to (v) for (R°) and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of the copolymer (P) and each one comprises
a group selected from a perfluorinated linear or branched alkyl chain comprising from 1 to 6 carbon atoms, —C(═O)F and —OC(═O)F; or
a group selected from a perfluorinated linear or branched alkyl chain comprising from 1 to 6 carbon atoms, —COOH and salts thereof with an organic cation, or an inorganic cation; —COOR with R being a linear or branched alkyl chain comprising from 1 to 6 carbon atoms; —COF; —CON(R₃₀₀)(R₃₀₁) wherein each of R₃₀₀ and R₃₀₁ are a hydrogen atom or are a linear or branched alkyl chain comprising from 1 to 6 carbon atoms; —(R)_{c}OH with c being 0 or 1 and R is a linear or branched alkyl chain comprising from 1 to 6 carbon atoms; —C(O)—O—C(O)R with R being a linear or branched alkyl chain comprising from 1 to 6 carbon atoms; —Br; —CN₂;
and the second chain ends of said first and second PFPE chain are bonded to each other via:
at least one first block, block (1), complying with formula (I):
[CR₁₀₀R₁₀₁—CR₁₀₂R₁₀₃]_{L\hat{ }}-(D)L- (I)
Wherein
L\hat{ } is 0 or an integer from 1 to 250,
L is 0 or an integer from 1 to 250,
D is a group of formula —(CR_{100*}R_{101*}—CR_{102*}R_{103*})— wherein at least one of R_{100*}, R_{101*} R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—;
with the proviso that, when L\hat{ } and L are both different from 0, the recurring units are statistically distributed,
R₁₀₀, R₁₀₁, R₁₀₂ and R₁₀₃ are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms;
at least one second block, block (2), complying with formula (II): 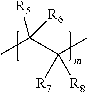
wherein
m is 0 or an integer from 1 to 5;
R₅ to R₈, each independently, is selected in the group comprising, preferably consisting of, —F, perfluorinated linear or branched alkyl chain having from 1 to 6 carbon atoms, and group of formula (III):
—R₂₀—(X)_{y} (III)
wherein
R₂₀ is a sigma bond, or linear or branched perfluoroalkyl chain comprising from 1 to 12 carbon atoms, preferably comprising and/or interrupted by at least one oxygen atom,
X is a functional group; and
y is an integer equal to 1 or 2;
with the proviso that in formula (II), at least one, preferably one, of R₅ to R₈ is group of formula (III);
at least one third block, block (3), complying with formula (IV): 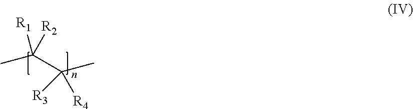
wherein
n is an integer from 1 to 3;
R₁ to R₄, each independently, is selected from the group consisting of fluorine atom, perfluorinated linear or branched alkyl group having from 1 to 6 carbon atoms, group of formula (V):
—(R₁₀)ₜ[C(R₁₁)(R₁₂)—C(R₁₃)(R₁₄)(R₁₅)]_{z} (V)
wherein
R₁₀ is an oxygen atom, or a bi-/tri-/tetravalent perfluorinated alkyl chain comprising from 1 to 24 carbon atoms and being optionally interrupted by at least one oxygen atom,
t is zero or 1,
z is an integer from 1 to 3,
R₁₁ to R₁₅, each independently, is selected from the group consisting of: fluorine atom, perfluorinated linear or branched alkyl group having from 1 to 6 carbon atoms and group of formula (VI):
-[(A)ₐ-(B)_{b}-(E)-(F)_{f}]ᵤ-(A)-T (VI)
wherein
u is zero or an integer from 1 to 50;
T is a perfluorinated alkyl group;
a is zero or 1,
each A is a PFPE chain;
b is zero or an integer from 1 to 3,
B is a block of formula (IV*):
—[C(R_{1\hat{ }})(R_{2\hat{ }})—C(R_{3\hat{ }})(R_{4\hat{ }})]— (IV*)
wherein
R_{1\hat{ }} to R_{4\hat{ }} each independently has the meaning defined above for each of R₁ to R₄, respectively;
E is a block of formula (I*)
—[CR_{100\hat{ }}R_{101\hat{ }}—CR_{102\hat{ }}R_{103\hat{ }}]_{e\hat{ }}-(D*)_{e*}- (I*)
wherein
e\hat{ } is 0 or an integer from 1 to 250,
each of R₁₀₀R_{101\hat{ }},R_{102\hat{ }} and R_{103\hat{ }} are each independently selected from halogen atom; linear or branched alkyl chain comprising from 1 to 6 carbon atoms; —OR₂₀₀ wherein R₂₀₀ is a linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀R_{101\hat{ }},R_{102\hat{ }} and R_{103\hat{ }} are a fluorine atom and the other of R₁₀₀ and R₁₀₁ and the other of R₁₀₂ and R₁₀₃ together form a perhalogenated cyclic ring having from 4 to 6 members, optionally comprising heteroatoms,
e* is 0 or an integer from 1 to 250, and
D* is a group of formula —(CR_{100*}R_{101*}—CR_{102*}R_{103*})— wherein at least one of R_{100*}, R_{101*} R_{102*} and R_{103*} is different from R₁₀₀, R₁₀₁, R₁₀₂, and R₁₀₃, such that (D) is different from —[CR₁₀₀R₁₀₁—CR₁₀₂R₁₀₃]_{L\hat{ }}—,
with the proviso that, when e\hat{ } and e* are both different from 0, the recurring units are statistically distributed;
f is 0 or an integer from 1 to 5;
F is a block of formula (II*):
—[C(R_{5\hat{ }})(R_{6\hat{ }})—C(R_{7\hat{ }})(R_{8\hat{ }})]—
wherein
R_{5\hat{ }} to R_{8\hat{ }}, each independently, is selected from the group consisting of —F, perfluorinated linear or branched alkyl chain having from 1 to 6 carbon atoms, and group of formula (III):
—R₂₀—(X)_{y} (III)
wherein
R₂₀ is a sigma bond, or linear or branched perfluoroalkyl chain comprising from 1 to 12 carbon atoms, optionally comprising and/or interrupted by at least one oxygen atom,
X is a functional group; and
y is an integer equal to 1 or 2;
with the proviso that in formula (II), at least one of R₅ to R₈ is group of formula (III);
with the proviso that:
in said formula (IV), at least one of R₁ to R₄ is a group of formula (V),
in said formula (IV*), at least one of R_{1\hat{ }} to R_{4\hat{ }} is a group of formula (V)
in said formula (V), one of R₁₁ or R₁₂ and one of R₁₃ to R₁₅, is a group of formula (VI),
in said formula (VI), the recurring units (A), (B), (E) and (F) are statistically distributed;
and
optionally, at least one fourth block-{block (4)}, block (4), comprising a PFPE chain;
with the proviso that
* in copolymer (P_{O—O})
said block (1), said block (2), said block (3) and, when present, said at least one block (4) are statistically distributed,
the sum of (n+b) is at least 1;
the sum of (L+L\hat{ }+e\hat{ }+e*) is at least 1;
the sum of (m+f) is at least 1.

16. (canceled)

17. A mixture, mixture (M1), comprising at least one copolymer (P) according to claim 1, and at least one of said PFPE peroxy and/or one or more of copolymers (P_{O—O})
wherein PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (Rf), comprising repeating units (R°) being independently selected from the group consisting of formulae (i) to (v) and having a peroxidic content (PO), defined as grams of active oxygen (Mw=16) in 100 g of PFPE peroxy between 0.1 and 4, and
wherein
repeating units R° are independently selected from the group consisting of:
(v) —CFXO—, wherein X is —F or —CF₃;
(vi) —CFXCFXO—, wherein X, equal or different at each occurrence, is —F or —CF₃, with the proviso that at least one of X is —F;
(vii) —CF₂CF₂CF₂O—;
(viii) —CF₂CF₂CF₂CF₂O—;
(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain; and
wherein copolymer (P_{O—O}) is block copolymer comprising a first and a second perfluoropolyether chain, PFPE chain, wherein each of said first and second PFPE chain is a chain (R_{f}) or is a chain (Rf_{O—O}) wherein (Rf_{O—O}) is a repeating units complying with any one of formulae (i) to (v) for (R°) and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of a copolymer (P) and each one comprises a group selected from a perfluorinated linear or branched alkyl chain comprising from 1 to 6 carbon atoms, —C(═O)F and —OC(═O)F; and the second chain ends of said first and second PFPE chain are bonded to each other via:
at least one first block, block (1), complying with formula (I):
—[CR₁₀₀R₁₀₁—CR₁₀₂R₁₀₃]_{L\hat{ }}-(D)L- (I);
at least one second block, block (2), complying with formula (II): 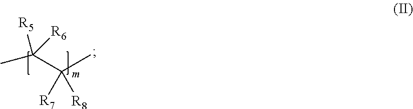
at least one third block, block (3), complying with formula (IV): 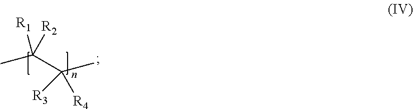
and
optionally, at least one fourth block, block (4), comprising a PFPE chain;
with the proviso that
* in copolymer (P_{O—O})
said block (1), said block (2), said block (3) and, when present, said at least one block (4) are statistically distributed,
the sum of (n+b) is at least 1;
the sum of (L+L\hat{ }+e\hat{ }+e*) is at least 1;
the sum of (m+f) is at least 1.

18. A mixture, mixture (M2), comprising at least one copolymer (P_{F}) as defined above according to claim 14, and at least one of at least one of copolymer (P), PFPE peroxy, one or more copolymers (P_{O—O}), and/or one or more copolymers (P_{F—O—O}),
wherein PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (Rf), comprising repeating units (R°) being independently selected from the group consisting of formulae (i) to (v) and having a peroxidic content (PO), defined as grams of active oxygen (Mw=16) in 100 g of PFPE peroxy between 0.1 and 4, and
wherein
repeating units R° are independently selected from the group consisting of:
(ix) —CFXO—, wherein X is —F or —CF₃;
(x) —CFXCFXO—, wherein X, equal or different at each occurrence, is —F or —CF₃, with the proviso that at least one of X is —F:
(xi) —CF₂CF₂CF₂O—;
(xii) CF₂CF₂CF₂CF₂O—;
(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently —For —CF₃ and T being a C₁-C₃ perfluoroalkyl alkyl chain;
wherein copolymer (P_{O—O}) is block copolymer comprising a first and a second perfluoropolyether chain, PFPE chain, wherein each of said first and second PFPE chain is a chain (R_{f}) or is a chain (Rf_{O—O}) wherein (Rf_{O—O}) is a repeating units complying with any one of formulae (i) to (v) for (R°) and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of a copolymer (P) and each one comprises a group selected from a perfluorinated linear or branched alkyl chain comprising from 1 to 6 carbon atoms, —C(═O)F and —OC(═O)F; and the second chain ends of said first and second PFPE chain are bonded to each other via:
at least one first block, block (1), complying with formula (I):
—[CR₁₀₀R₁₀₁—CR₁₀₂R₁₀₃]_{L\hat{ }}-(D)L- (I);
at least one second block, block (2), complying with formula (II): 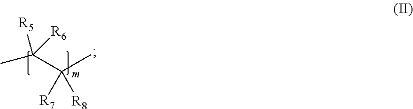
at least one third block, block (3), complying with formula (IV): 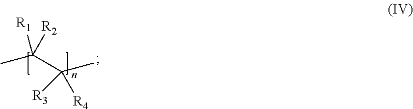
and
optionally, at least one fourth block, block (4), comprising a PFPE chain;
with the proviso that
* in copolymer (P_{O—O})
said block (1), said block (2), said block (3) and, when present, said at least one block (4) are statistically distributed,
the sum of (n+b) is at least 1;
the sum of (L+L\hat{ }+e\hat{ }+e*) is at least 1;
the sum of (m+f) is at least 1; and
wherein copolymer (P_{F—O—O}) is a block copolymer comprising a first and a second perfluoropolyether chain, PFPE chain, wherein each of said first and second PFPE chain is a chain (R_{f}) or is a chain (Rf_{O—O}) wherein (Rf_{O—O}) is a repeating units complying with any one of formulae (i) to (v) for (R°) and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of copolymer (P) and each one comprises a group selected from a perfluorinated linear or branched alkyl chain comprising from 1 to 6 carbon atoms, —COOH and salts thereof with an organic cation, or an inorganic cation; —COOR with R being a linear or branched alkyl chain comprising from 1 to 6 carbon atoms; —COF; —CON(R₃₀₀)(R₃₀₁) wherein each of R₃₀₀ and R₃₀₁ are a hydrogen atom or are a linear or branched alkyl chain comprising from 1 to 6 carbon atoms; —(R)_{c}OH with c being 0 or 1 and R is a linear or branched alkyl chain comprising from 1 to 6 carbon atoms; —C(O)—O—C(O)R with R being a linear or branched alkyl chain comprising from 1 to 6 carbon atoms; —Br; —CN₂; and the second chain ends of said first and second PFPE chain are bonded to each other via:
at least one first block, block (1), complying with formula (I):
—[CR₁₀₀R₁₀₁—CR₁₀₂R₁₀₃]_{L\hat{ }}-(D)L- (I);
at least one second block, block (2), complying with formula (II): 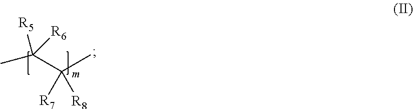
at least one third block, block (3), complying with formula (IV): 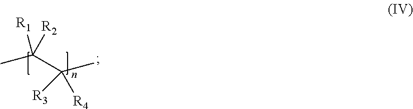
and
optionally, at least one fourth block, block (4), comprising a PFPE chain;
with the proviso that
* in copolymer (P_{F—O—O})
said block (1), said block (2), said block (3) and, when present, said at least one block (4) are statistically distributed,
the sum of (n+b) is at least 1;
the sum of (L+L\hat{ }+e\hat{ }+e*) is at least 1;
the sum of (m+f) is at least 1.

19. The copolymer (P) according to claim 1, wherein X is selected from the group consisting of: —SO₂F, —SO₃H, —COOH, —COF, —CN, —Br and —CONH₂.

20. The copolymer (P_{O—O}) according to claim 15, wherein the copolymer (P_{O—O}) is a copolymer (P_{F—O—O}) and wherein the group selected from
a perfluorinated linear or branched alkyl chain comprising from 1 to 6 carbon atoms, —C(═O)F and —OC(═O)F; or
a group selected from a perfluorinated linear or branched alkyl chain comprising from 1 to 6 carbon atoms, —COOH and salts thereof with an organic cation, or an inorganic cation; —COOR with R being a linear or branched alkyl chain comprising from 1 to 6 carbon atoms; —COF; —CON(R₃₀₀)(R₃₀₁) wherein each of R₃₀₀ and R₃₀₁ are a hydrogen atom or are a linear or branched alkyl chain comprising from 1 to 6 carbon atoms; —(R)_{c}OH with c being 0 or 1 and R is a linear or branched alkyl chain comprising from 1 to 6 carbon atoms; —C(O)—O—C(O)R with R being a linear or branched alkyl chain comprising from 1 to 6 carbon atoms; —Br; —CN₂;
is selected from a perfluorinated linear or branched alkyl chain comprising from 1 to 6 carbon atoms, —COOH and salts thereof with an organic cation, or an inorganic cation; —COOR with R being a linear or branched alkyl chain comprising from 1 to 6 carbon atoms; —COF; —CON(R₃₀₀)(R₃₀₁) wherein each of R₃₀₀ and R₃₀₁ are a hydrogen atom or are a linear or branched alkyl chain comprising from 1 to 6 carbon atoms; —(R)_{c}OH with c being 0 or 1 and R is a linear or branched alkyl chain comprising from 1 to 6 carbon atoms; —C(O)—O—C(O)R with R being a linear or branched alkyl chain comprising from 1 to 6 carbon atoms; —Br; —CN₂.
